(19) United States
(12) Patent Application Publication
(10) Pub. No.: US 2002/0013809 A1
(43) Pub. Date: Jan. 31, 2002

(54) Processing device, remotely operated controlling device, remotely operated system and recording medium

(76) Inventors: Nobuyuki Hashimoto, Inagi (JP); Kazuhiko Akasaka, Yokohama (JP)

Correspondence Address: STAAS & HALSEY LLP, 700 11TH STREET, NW, SUITE 500, WASHINGTON, DC, 20001, US

(21) Appl. No.: 09/789,677

(22) Filed: Feb. 22, 2001

(30) Foreign Application Priority Data
Jul. 31, 2000 (JP) 2000-230159

(51) Int. Cl. G06F 15/16

(52) U.S. Cl. 709/203; 709/206; 709/219

(57) ABSTRACT

Technology to effect remote operation of a device without creating a processing load on the device. In addition, a technology is provided to simplify the creation of correct command line text. The following are carried out by a device to determine whether a specific file is stored on another device and if the specific file is stored on the another device, the processes indicated by the specific file is executed.

### CROSS REFERENCE TO RELATED APPLICATIONS

This application is based upon and claims priority of Japanese Patent Application No. 2000-0230159 filed Jul. 31, 2000, the contents being incorporated herein by reference.

### BACKGROUND OF THE INVENTION 1. Field of the Invention

This invention relates to remotely operated devices. 2. Description of the Related Art

At present, personal computers are being used not only in corporations, but they are also widely used in general households in such diverse applications as the creation of work-related documents and data, the management of individual schedules, sending and receiving email and for browsing web pages.

Personal computers are also connected to video tape recorders and used to run them or to edit recorded video images. They are also used to run other devices that they can be connected to. There is application software that can be run on personal computers having the same functions as these devices and are often used in place of the aforementioned devices.

To accomplish the above sorts of processes and controls, many different types of application software are installed on the personal computer and those are stored, along with the many different types of data and information that are generated by that software on the hard disk of the personal computer.

When this sort of personal computer is in one home, there are often times when it is necessary to run processes on the computer in the house from a remote location or to view or browse data or information that is stored on the computer.

A technology for remote operation of the personal computer has been necessary to execute processes of this sort.

Among the known techniques for operating computers remotely are those described in Japanese Unexamined Patent Application Publication H10 49452 and H08 297616.

A computer is disclosed in Japanese Unexamined Patent H10 49452 that is equipped with an e-mail receiving function that analyzes and executes control codes that may be embedded in received electronic mail.

It is therefore possible to send the aforementioned computer electronic mail that contains a command line in the text to control or manipulate data residing on the computer.

Japanese Unexamined Patent H08 297616 describes an electronic mail service manager that is equipped with electronic mail send and receive functions (a so-called mail server) and it extracts electronic mail containing command lines from among the electronic mail received from the user, analyzes those command lines and executes them. Note that this application is characterized by the capacity for specifying the time that a particular command line text is to be executed and making it possible for the user to execute command lines at the desired times and in the desired order. Both of the above publicly known technologies make the remote operation of computers possible.

As of today, electronic mail is frequently used in the collection and distribution of data and communications with other parties and the current trend is for the number of people using electronic mail to increase.

For this reason, mail servers are having to process huge amounts of incoming electronic mail and the computers that these users employ are receiving greater quantities of electronic mail.

In the aforementioned publicly known technologies, electronic mail is used to operate the computer remotely and they require a process by which the control text (command line text) is extracted from the electronic mail that contains such text, when the electronic mail is received.

For this reason, it is necessary to determine, for each piece of incoming electronic mail, whether that electronic mail contains control text (command line text), which causes the processing burden of the computer to increase in proportion to the amount of incoming electronic mail.

Also, even though a piece of electronic mail may have not been sent out for use in remote control operations, it is possible that the computer could mistakenly determine that the text contained in the body of the electronic mail is a control text (command line text) and cause the computer to malfunction.

Furthermore, in order to properly operate the computer remotely, the user must write the control text (command line text) correctly. If this is not done, when the computer receives electronic mail containing control text (command line text), it will either not be properly extracted or, if the control text (command line text) is extracted from the electronic mail, it could cause the computer to malfunction.

For example, many compact, highly portable cellular terminals such as PDA's or cellular telephones equipped with communications functions are used when going out. However, due to the fact that such cellular terminals are compact, the keyboards used for input are also generally small. Thus, it is difficult to input all of the aforementioned control text (command line text) correctly, placing the burden of input on the user.

### SUMMARY OF THE INVENTION

The purpose of this invention is to provide technology for realizing remote operation that involves no processing burden. Another purpose is to provide technology for easily creating correct command lines of text.

This invention employs the following configuration in order to eliminate the above problems.

Depending upon preferences, the configuration may be such that it judges whether a specific file exists on another device and, if the aforementioned specific file does exist, it executes the process specified in the file.

Also, depending upon preferences, the configuration could be such that an input form would be displayed for entering values into categories corresponding to the contents of the selected process, data corresponding to the values and categories of the entered values using the aforementioned input form would be taken in and using the values in said categories, a command line text could be generated for executing the aforementioned process at the other device.

It would also be possible to have the following sort of configuration, if desired. A system made up of terminal devices and administration devices, where a determination is made regarding the existence of specific files on the aforementioned terminal devices or the aforementioned administration devices and if the aforementioned specified files do exist, the processes indicated in said files are executed.

According to an embodiment of the present invention, a processing device that is equipped with a way to determine whether a specific file is present on another device and a control means is provided which executes the process indicated by the file if that specific file is present.

This processing device may also include a means for transferring the aforementioned specified file that is present on another device to a destination device, and executes the process indicated in the file using the specified file that was transferred to the destination device.

The processing device may also be equipped with a means for sending out the results of running the aforementioned process to the device used to generate the aforementioned file.

A remote operation control device that includes display means for displaying the input forms for entering values into categories corresponding to the processing content selected, means for obtaining information corresponding to the values that are input and their respective categories using the aforementioned input form and means for generating command line text that runs the aforementioned processing content on another device using the values “cc” to the aforementioned categories may also be provided.

This remote operation control device may also be equipped with means for storing, in a specific file, the command line text that was generated above.

A remote operation system that includes a terminal device and an administration device may also be provided. The aforementioned terminal device may have means for determining whether a specific file is present on the aforementioned administration device and control means for executing the process indicated in the file in the event that the aforementioned specified file does exist.

The remote operation system described may further include means for transferring the aforementioned specified file that exists on the aforementioned administration device to a destination device and the aforementioned control means may use the specified file that was transferred to execute the process indicated in the file.

The terminal device may be equipped with notification means for sending out the results of running the aforementioned process to the device that was used in generating the aforementioned file.

The remote operation system described above may be equipped with means for displaying the input form used for entering values into the categories corresponding to the content of the selected process, means for obtaining information corresponding to the values and categories entered using the aforementioned input form and means for generating command line text that runs the aforementioned process content on another device using the values of the aforementioned categories.

The aforementioned administration device may be equipped with means for storing, in a specific file, the command line text generated above.

According to the present invention, a recording medium which can be read by a computer and which contains a program for running the process indicated in the file in question if it is determined that said file exists may also be provided.

The aforementioned program may run the process using the specified file that was transferred into the destination device after said file is transferred from the other device to the destination device.

The aforementioned program may also send out the results of running the aforementioned process to the device that was used in the generation of the aforementioned file.

A recording medium, which can be read by a computer and which displays the input form for entering values into the categories according to the content of the selected process, obtains the values and categories entered using the aforementioned input form and the corresponding information and contains a program for generating the command line text that runs the content of the aforementioned process on the other device using the values in the aforementioned categories.

The recording medium containing the aforementioned program may store the aforementioned generated command line text in the specified file.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a system configuration diagram according to an embodiment of the invention.

FIG. 2 is a diagram showing a hardware configuration of a computer according to the present invention.

FIG. 3 is a flow chart showing the overall process flow for an embodiment of the invention.

FIG. 4 is a diagram showing an example of the settings screen displayed on the remote computer (1 of 2).

FIG. 5 is a diagram showing an example of the settings screen displayed on the remote computer (2 of 2).

FIG. 6 is a diagram showing and example of a web page provided to the client by the CGI program on the server (1 of 2).

FIG. 7 is a diagram showing and example of the web page provided to the client by the CGI program on the server (2 of 2).

FIG. 8 is a flow chart showing the process carried out by the CGI program that creates the command line text.

FIG. 9 is a diagram showing an example of the command line text in the file created using the process of this invention.

FIG. 10 is a diagram showing a flow chart of the process pertaining to the execution of the command line text using the remote computer.

FIG. 11 is a diagram showing the correspondence between the command line text and the application program.

FIG. 12 is a diagram showing the output of the video recording scheduled using the command line text.

### DESCRIPTION OF THE PREFERRED EMBODIMENTS

Reference will now be made in detail to the preferred embodiments of the present invention, examples of which are illustrated in the accompanying drawings, wherein like reference numerals refer to like elements throughout.

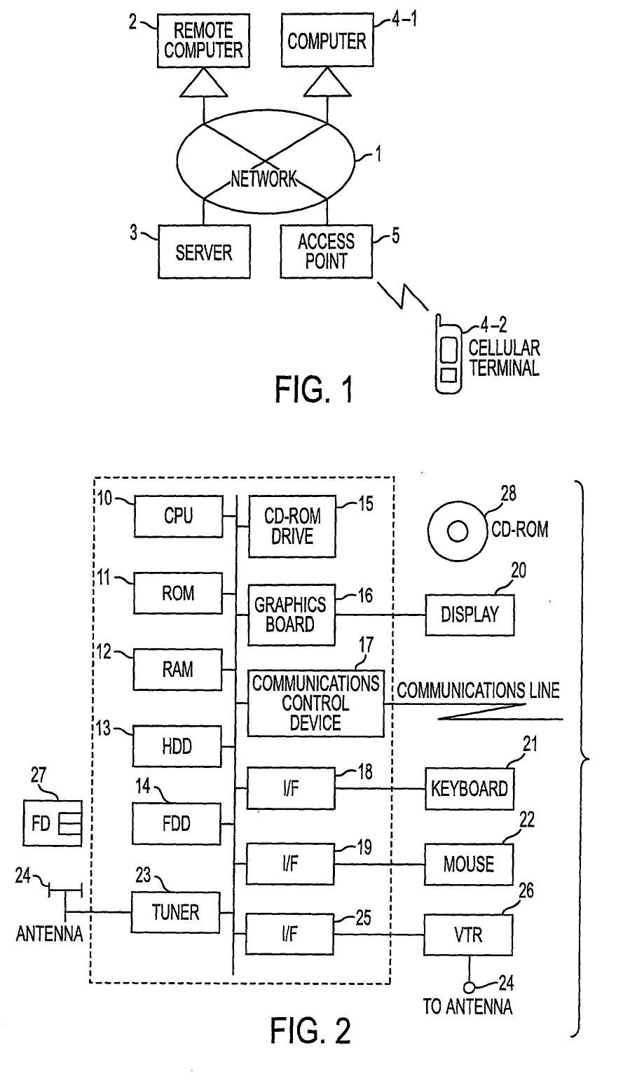

In FIG. 1, element 1 is a network, 2 is a remote computer, 3 is a server, 4-1 is a computer, 4-2 is a cellular terminal and 5 is an access point.

Here the network 1 is made up of a telephone line network, a LAN (local area network) or the Internet and the remote computer 2 is a computer which is the object of the remote operation based on the process of this invention while the server 3 is the computer that is used in the process of this invention.

The computer 4-1 and the cellular terminal 4-2 are devices which direct the remote operation of the remote computer 2. Both are equipped with communications control functions and use the network 1 to access the server 3. The cellular terminal 4-2 is equipped with a function for wireless access of the access point 5 to access the server 3.

These devices which direct the remote operation of this invention may be physically connected to the network 1 using a wire or may be wireless. Note that FIG. 1 shows an example in which the computer 4-1 is connected to the network 1 using a wire and the cellular terminal 4-2 is connected to the network 1 in a wireless manner.

The aforementioned remote computer 2, the server 3 and the computer 4-1 are all computers having publicly known configurations such as those of personal computers or workstations. The cellular terminal 4-2 may be a PDA or cellular telephone that is equipped with at least one data communications control function and a portable computer equipped with the same sort of configuration as the above types of computers would also be possible.

The remote computer 2 does not have to be the same sort of computer as described above. It does not matter what type of device it is as long as it is a device equipped with a configuration capable of executing the processes of this invention. For example, peripheral devices or electrical appliances that can be connected to computers would be suitable.

The following is a description of the computer hardware pertaining to this invention as described above.

As shown in FIG. 2, the hardware of this computer is made up of a CPU 10, ROM 11, RAM 12, a hard disk drive (HDD) 13, a floppy disk drive (FDD) 14, a CD ROM drive 15, a graphics board 16, as well as a network card, modem and other types of communications control devices 17.

A display 20 is connected to the graphics board 16 and a communications line is connected to the communications control device 17. The computer shown in FIG. 2 is equipped with the interfaces (I/F) 18 and 19, to which a keyboard 21 and a mouse 22 are connected.

The example used in this embodiment is the control of videotaping of a television broadcast. For this reason, a tuner 23 is built into the system and an antenna 24, which receives the television broadcast, is connected thereto. If videotaping of the television broadcast is to be performed using a VTR 26, which is an external device, only the interface (I/F) 25 for connecting the VTR 26 need be included. Note that the content of the remote operations is not limited to what is necessary for this configuration.

In the aforementioned configuration, the CPU 10 runs various processes using program control and the various processes and controls used are those that are based on the program of this invention.

The ROM 11 has stored on it the start-up program and, when the power supply is turned on, it is read in and run by the CPU 10.

The RAM 12 is used to hold the results of the program processes or for holding the operating data for the processes when the program controlling the computer is opened. The display data opened in the RAM 12 is displayed on the display 20 through the graphics board 16.

The hard disk drive 13 and the floppy disk drive 14 are devices for recording program and control data, or documents or image data that have been created, onto their respective recording media (hard disks and floppy disks).

The CD-ROM drive 15 is used to read the data or programs recorded on a CD-ROM 28.

The communications control device 17 is used to exchange data with other devices over communications lines and for downloading programs.

A keyboard 21 is composed of several alphanumeric and arrow keys and is used for the purpose of entering all types of data. A mouse 22 is used to make selections using a mouse cursor shown on a screen of the display 20.

The program for running the process of this invention on a computer is stored in advance on the hard disk drive 13 from a floppy disk 27 or the CD-ROM 28 by using the floppy disk drive 14 or the CD-ROM drive 15. This program may also be stored on the hard disk drive 13 using a communications line and the communications control device 17.

Specific instructions load the aforementioned program into the RAM 12 and the process of this invention is executed, controlling the different parts of the computer.

The recording medium upon which the program of this invention is recorded is shown as described above, but it is not limited to these types. As long as the computer is capable of reading it, there are no limits placed on the type of recording medium or the recording methods.

The program of this invention that is received by way of the communications control device 17 through the communications line described above, could also be configured so that it is opened up directly and run in the main memory device (RAM 12) without being temporarily stored in a supplementary memory device.

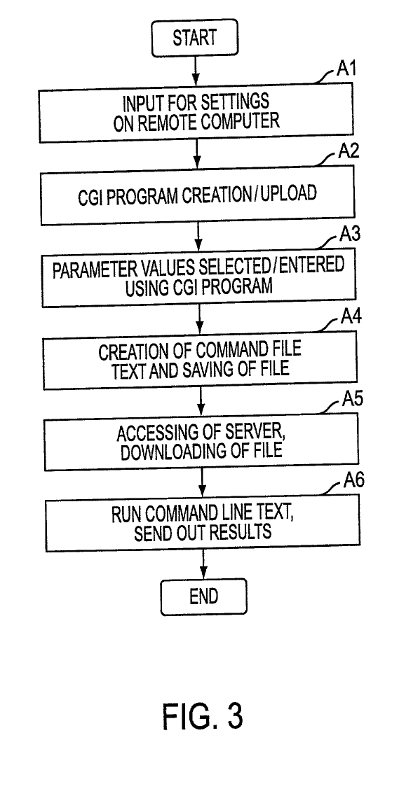

FIG. 3 is a flow chart showing the general flow of the process of this embodiment of the invention.

First, all of the various settings are performed that will make it possible to run the remote operation of this invention on the remote computer 2, where the object of the remote operation and the settings information is stored (Al).

These settings include information for the purpose of using the server 3 in the remote operation of this invention and the information applied to the CGI program that is run on the server 3.

The user creates the CGI program that is run on the server 3 and the CGI program is uploaded on the server 3 by an FTP using the aforementioned settings (A2).

Then, the user accesses the server 3 from a remote location using the other devices 4-1 and 4-2 and, using the uploaded CGI program, the necessary parameter values to the selection of the command line text are selected and input (A3). The CGI program uses those parameter values to create the command line text and store it in a file (A4).

The remote computer 2 accesses the server 3 based on the settings information saved in Al and determines whether the aforementioned file is present on the server 3. If the file is present, the remote computer 2 will download the file from the server 3 (A5).

The command line text contained in the downloaded file is run by the remote computer 2 and the results thereof are sent to an address contained in the aforementioned settings information (A6).

The above describes the way in which the process of this invention is run using the remote computer 2, the server 3, as well as the other devices 4-1 and 4-2.

Next, the processes in the aforementioned flow chart will be described.

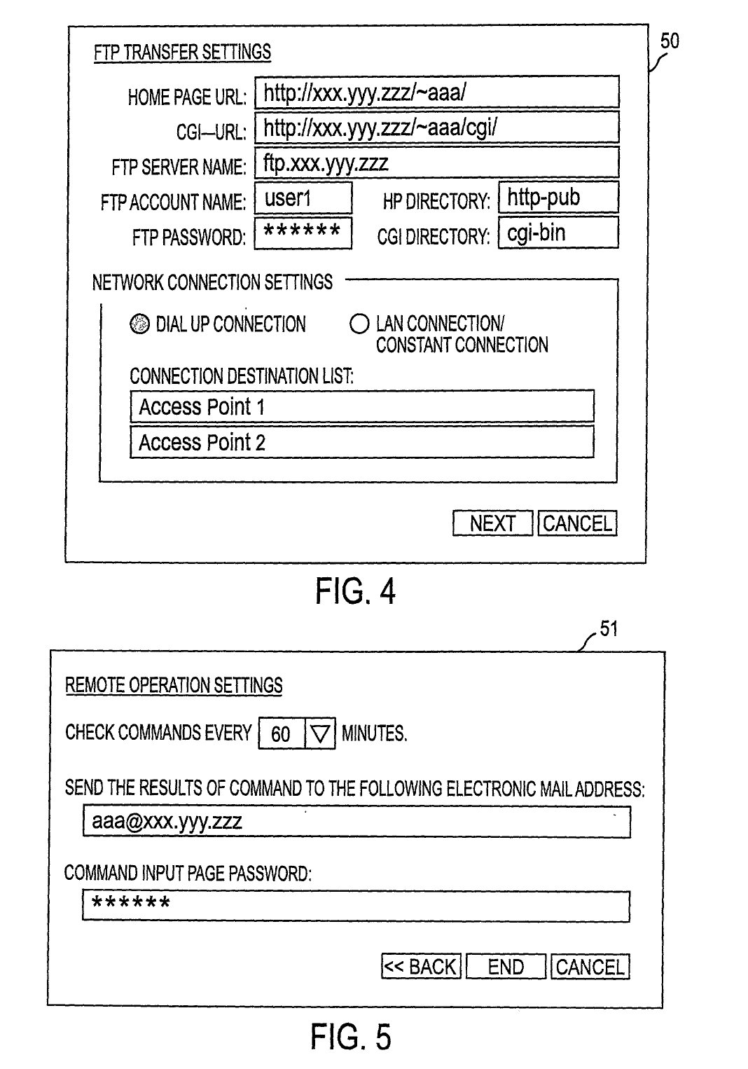

First, the settings in Al in FIG. 3 will be described. The program of this invention operating on the remote computer 2 displays the screens shown in FIG. 4 and FIG. 5 and the user enters data for these settings. The data that has been entered is then stored as a file on the remote computer 2.

FIG. 4 and FIG. 5 show examples of the settings screens displayed on the remote computer 2.

In this embodiment, the remote computer 2 and the server 3 use FTP (File Transfer Protocol) for transferring data and CGI (Common Gateway Interface) programs for running the processes of this invention on the server 3. Note that it would also be acceptable to use HTTP (HyperText Transfer Protocol) as a data transfer method and the processes run on the server 3 could be performed using some other method.

A settings screen 50 shown in FIG. 4 is one used for making the settings pertaining to FTP transfers as well as other data settings including the home page and CGI URL (Uniform Resource Locator), the FTP server name and the account name for logging onto that server and password, the home page directory (HP Directory) to which the HTML, image and other files are to be transferred using FTP transfer and the CGI directory to which the CGI program is transferred. By transferring files to these directories, it is possible to browse home pages on the Internet.

To access an FTP server and for the network connection settings, either a dial-up connection may be used or a LAN connection/constant connection may be used. In this case, where a dial-up connection has been selected, the access point to be used would be selected from a list of connections.

A settings screen 51 shown in FIG. 5 is used for the remote operation settings, the time interval settings for verifying the presence of the file in which the commands have been stored, for the electronic mail addresses for electronic notification of the results of the process carried out based on the content of the file received via FTP transfer and for setting the passwords used for identification purposes when logging into the input page (Web page) to create the command lines. In this way, the data is set up in advance on the remote computer 2.

After that, as shown in A2 in FIG. 3, the CGI program that is run on the server 3 is created and that CGI program is uploaded to the server 3 via FTP using the data from the aforementioned settings.

This CGI program can be written using any well known editor and the CGI program thus created will be transferred to the server 3 by the program of this invention according to the data in the aforementioned settings.

Note that the password for this CGI program will be set up using the command input page identification password set up using the settings screen 51.

This completes the preparation for the remote operation of the remote computer 2.

When it is necessary to operate the computer 2 from a remote location, the server 3 is accessed from another device and a command line text is written. In this example, software for scheduling the videotaping of a program has been installed on the remote computer 2.

The example for this embodiment describes the use of a cellular telephone equipped with a data communications function (cellular terminal 4-2) for the purpose of accessing the server 3 and writing the command line text. Note that like any well known model, this cellular telephone would be equipped with number keys, scroll keys and an enter button for alphanumeric input and the scroll key would allow one to scroll the contents displayed on the screen or to move the cursor and the enter button would allow the selection of such categories as data links to web pages, buttons or list boxes on which the cursor was located.

As shown in A3 in FIG. 3, the user uses the CGI program on the server 3 to enter or select the values for the parameters necessary for writing command line text.

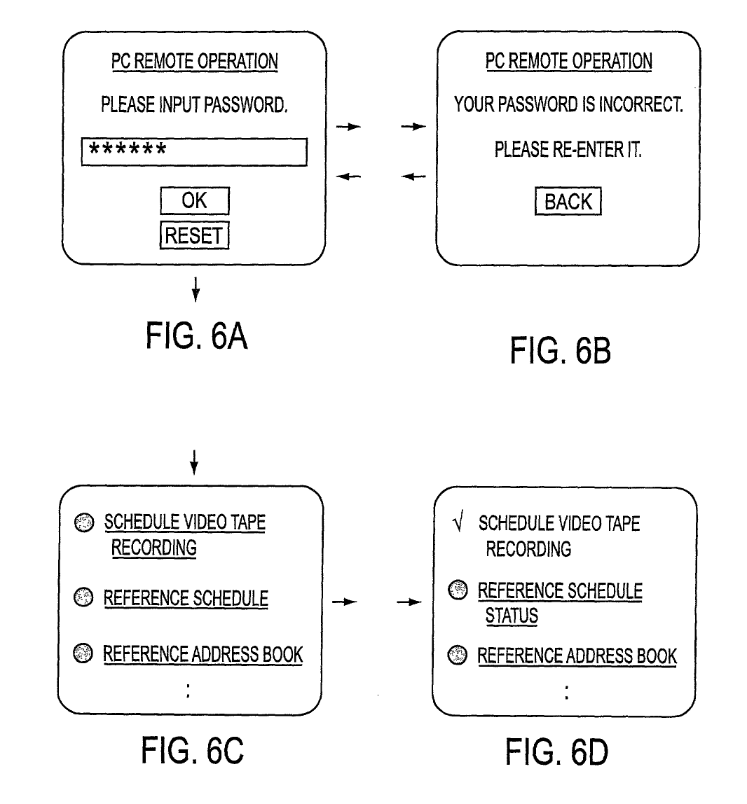

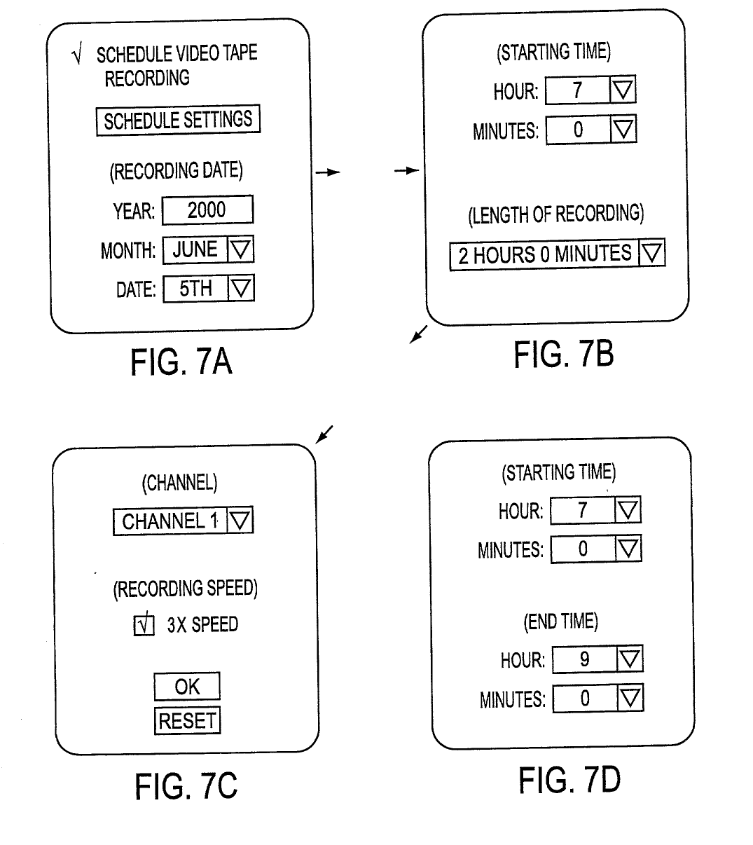

FIG. 6 and FIG. 7 show examples of a web page display provided by the client based on the CGI program on the server 3.

First, a particular URL that is composed of a specific file (such as index.cgi) name provided by the URL and top page of the CGI specified by the aforementioned settings screen 50 is accessed. In this example, the URL is http://xxx.yyy.zzz/~aaa/cgi/index.cgi.

When this URL is accessed, a web page like the one shown in FIG. 6 (a) is displayed. This web page is a command input page for the purpose of writing the command line text and it will request that the user input a password.

If an incorrect password is entered, the identification process will notify the user by displaying a web page like the one shown in FIG. 6(b). If the password entered was correct, a web page like the one shown in FIG. 6(c) will be displayed.

In this example, to schedule videotaping on the remote computer 2, schedule videotaping is selected from the menu. This selection will cause a web page to be displayed with a menu pertaining to scheduling a videotaping like the one shown in FIG. 6(d). From the list displayed, the schedule settings item is selected.

Under schedule settings, a web page like the one shown in FIG. 7(a)-(c) will be shown. Here, FIG. 7(a)-(c) show a single web page and the scroll operation is used to move through the screen display.

In FIG. 7(a), the settings for the date of the videotaping are made. The number of the year is entered directly, while the desired month and date are selected from values displayed in a list box.

In FIG. 7(b), the starting time and the duration of the videotaping are set up. The desired values are selected from among those presented in a list box provided for the hour and minute of the starting time as well as the duration. Note that the duration of the videotaping does not have to be specified as shown in FIG. 7(b), but this may be accomplished by arranging a web page for specifying a videotaping end time as shown in FIG. 7(d).

In FIG. 7(c), the channel of the program to be videotaped and the recording speed are set. The desired channel is selected from a list of choices that is provided in a box and the recording speed is set by placing a check mark in the check box for 3× recording speed or leaving it blank for regular speed recording.

When the selection and input of the parameter values for each of the necessary categories for writing a command line text using the CGI program of the server 3 is done as outlined above, a notice containing the categories and the corresponding parameter values will be delivered to the CGI program making the command line text and a request will be made for the creation of a command line text. Note, in addition to the categories and the corresponding parameter values, this notice will also contain information indicating which menu is to be selected.

Now the creation of the command line text shown in A4 in FIG. 3 will be described in detail.

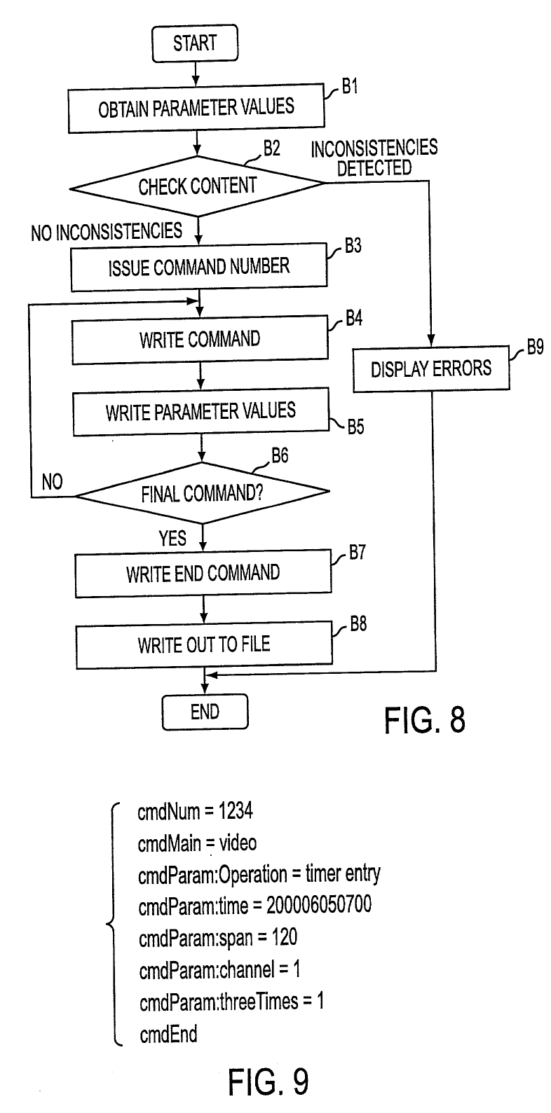

FIG. 8 shows a flow chart of the process carried out by the CGI program creating the command line text. First, this CGI program obtains the categories and the corresponding parameter values as described above (B1). Next, the contents of the parameter values that were obtained is checked (B2).

During this check, the CGI program will look for, for example, the selected parameter values and the entered values pertaining to the necessary categories and also check for inconsistencies between the categories and the parameter values. Note that in the scheduling of the videotaping in this example, the CGI program checks to see that the date of the videotaping occurs on a date later than the current date.

If the above check reveals inconsistent data or missing selections or input, a web page displaying an error message will be sent to the cellular telephone asking that the parameter values, selections or input be re-entered (B9).

If the above check reveals no inconsistencies, then creation of the command line text will begin.

First, a command number is issued and written to memory. The command numbers are counted upward sequentially, incrementing each time a command line text is created (B3).

Next, the categories and the corresponding parameter values that were delivered will be used to write out the parameter values and commands based on the menu that was selected (B4-B5).

Once all of the commands and the parameter values have been written out using the categories and the corresponding parameter values that were sent out, an end command will be written at the end of the command line text and the command number, the command/parameter value pair and the end command will be written out to a file and the main process will end (B6-B8). Note that these files are stored in the same directory as the CGI program.

Again, if the aforementioned files already exist, additions will be made to the existing command line text. If those files do not exist, a new file will be created under a specific name (for example, data.cgi).

FIG. 9 is an example of how the command line text looks when it is written out as a file created by the process shown in FIG. 8 using the parameter values selected in FIG. 6 and FIG. 7. The command line text in this invention indicates the series written from “cmdNum” to the following “cmdEnd”.

In FIG. 9, the “cmdNum” command indicates the beginning of the command line text and the command number. Its value is given as “1234”. The “cmdMain” command indicates which menu has been selected and the parameter value “video” indicates that a selection has been made to schedule a video tape recording. These parameter values are also indicated by the application programs that run the processes. These will be described later.

The “cmdParam” command indicates the parameters to pass over to the application program and the text that follows indicates the types of parameters.

The “Operation” parameter in this example indicates what the application program should be made to do and the “timer entry” parameter value indicates that a video tape recording is to be scheduled.

The parameter “time” indicates at what time and on what date the video tape recording is to be scheduled and the parameter value “200006050700” means that recording has been set to begin at 7:00 am on Jun. 5th, 2000 (Western calendar). Note that this parameter value was generated by the CGI program from the parameter values delivered based on the input and the selection of the starting time and date of the video tape recording in FIG. 7.

The parameter “span” indicates the duration of the video tape recording and a parameter value of “120” means that the duration of the video tape recording has been set to 120 minutes (2 hours).

The parameter “channel” indicates the broadcast channel number and the parameter value “1” means that the channel will be set to channel number 1.

The parameter “threeTimes” indicates the speed of the video tape recording and the parameter value means that the recording speed has been set to three times the speed. In the same way, when the recording speed has been set to standard speed, the parameter value will be “0” .

The “cmdEnd” command written at the end indicates the end of the command line text. Note that when more than one command has been generated, the start command indicating the next command line text will be written subsequent to this end command.

Next the process of the remote computer 2 in AS and A6 shown in FIG. 3 will be explained in detail.

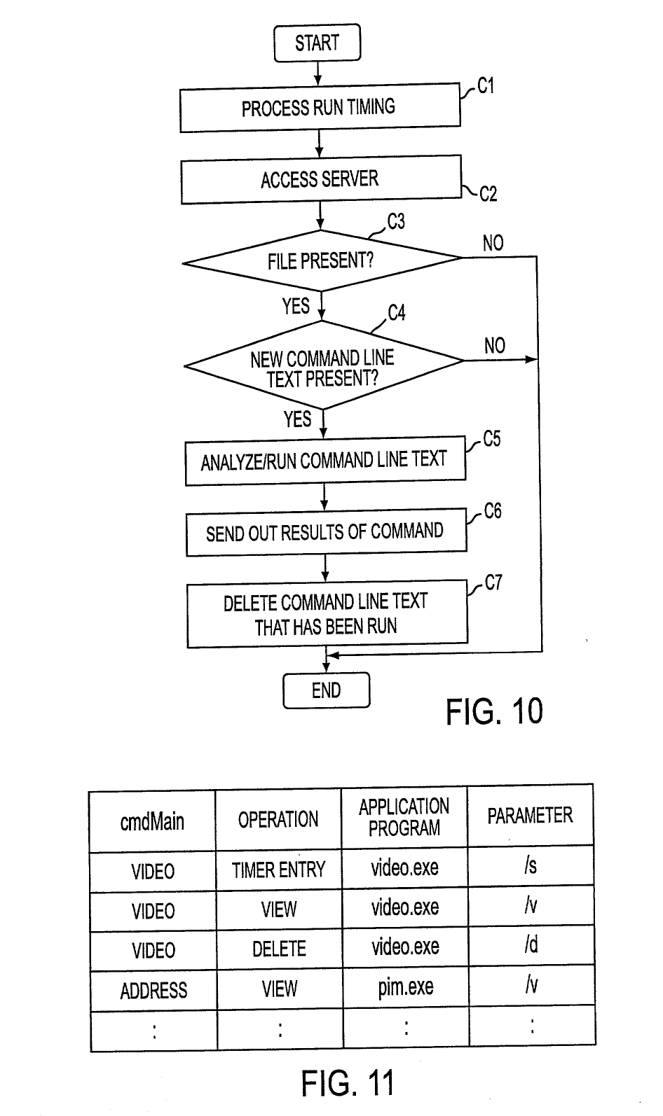

FIG. 10 shows a flow chart of the process pertaining to the execution of the command line text using the remote computer.

First, the program of this invention in the remote computer 2 determines the process execution timing and accesses the server 3 (C1 and C2).

Here the process execution timing of C1 coincides with the time interval for verifying the presence of the file specified using the set-up screen 51 in FIG. 5.

Note that if the remote computer 2 goes into a suspended state when the user goes out, a timer will be started when that operating system goes into suspend mode designating the time that was specified above. After the time designated for this timer has passed, the operating system causes the remote computer 2 to resume operation from the suspend mode. The program of this invention is notified of this, so the program of this invention begins to access the server 3 in response to the notification from the operating system.

The run timing does not have to follow these intervals as long as the server 3 is accessed when other application programs run a dial-up connection to use the network in a normal operating state, or when the system goes out of suspend mode in response to an incoming call. Also, when accessing this server 3, the FTP server name, account name and password designated at the settings screen 50 in FIG. 4 will be used to log in.

Once logged into the FTP server, the system determines whether the specified file (data.cgi), which contains the command line text, is present in the CGI directory designated using the settings screen 50 in FIG. 4 (C3). If the file is not present, this process will end. If the file does exist, it will be downloaded and it will be determined whether a new command line text is present (C4).

Here, a dial-up connection is being used to access the server 3 and the connection may be broken after this file has been completely downloaded. Doing so will reduce the length of time that the telephone line is being used.

Note that it is not necessary to this invention that the telephone connection be broken immediately after this file is downloaded.

That is, if the downloaded file contains command line text, the results of running the process based on that command line text will be delivered via electronic mail as described below. At that point, if the telephone connection is broken immediately after the file is downloaded, a dial-up connection will have to be made which could result in increased charges.

In the same way, the matter could be determined by basing it on the length of the dial-up connection to the server 3. If the results of the process (described below) cannot be sent out before the next unit of time charged for using the telephone once the file has been completely downloaded, the connection could be broken.

Here, if the file is present but there is no command line text even once it has been downloaded, this process will assume that there is no new command line and end. If there is a connection to a telephone line, it will also break that connection.

When there is a command line text in the downloaded file, the command line text is analyzed and a process is executed based on the results of that analysis. If there is more than one command line text, all of them will be analyzed and run. (C5) After the process based on this command line text has been run, the results of the process will be sent via electronic mail to the address designated in FIG. 5. When a dial-up connection is used in accessing the server 3, if the telephone connection has been broken after downloading the aforementioned file at the time of this notice, the dial-up connection will be re-established (C6).

The text of this electronic mail contains the contents of the process and its results (normal completion/failure). If the electronic mail address of the device that performs the selection/entry of the parameters using the web page is designated as the aforementioned address (a cellular telephone in this example), the user would be able to learn the results of running the remote operation immediately. Note that this could be configured to send out the parameter values used in this process as well.

Instead of sending out the results of running the process via electronic mail, an HTML file containing the aforementioned results could be uploaded to the server 3 and that HTML file could be browsed and verified from the cellular telephone.

After running the process based on the aforementioned command line text and sending out the results, the commands that have been run are deleted from the file on the server 3. When a dial-up connection is being used to access the server 3, and this command line text is deleted, the telephone connection will be broken. (C7)

The deletion of this command line text could be managed by deleting the command line text in the file that was downloaded to the remote computer 2 and then uploading that file (without the deleted portion) to the server 3.

Note that when there are several sections of command line text in a file, the running of the command lines as well as the uploading of files from which command line text has been deleted to the server 3 could be performed on a per-command basis or on a repeat basis. It could also be configured so that the command line text would be deleted from the files to be uploaded to the server 3 after all of the command lines had been run.

Instead of the above method, the command line text (command number) could be sent from the remote computer 2 to the server 3 and the command line text in question could be deleted from the file by a CGI program on server 3.

The above methods allow the remote operation of a computer and the computer that is being operated remotely determines whether a specific file is present on another device (server), so remote operation instructions can be recognized with a low load level.

To run the operation according to the specified file that was downloaded from the server, if the server is accessed using a dial-up connection on a telephone line, the telephone connection can be broken once the file has been completely downloaded, making it possible to avoid dedicated telephone lines or increased telephone charges.

And, if the address of the device used for giving the remote operation instructions is registered as the destination for the results of the process, the user would be able to know immediately after the process had been run on the remote computer what the results had been.

The command line texts run by the computer are not written directly by the user. The user selects the parameters and using the selected parameters, the program generates the command line text. This keeps erroneous command line text from being created.

Lastly, a description will be made of examples of the results of running command line text and the correspondence between the command line text and the application program.

FIG. 11 is a diagram showing the correspondence between the command line text and the application program. This correspondence is stored in the remote computer as administration information for the purpose of having the program of this invention that runs on the remote computer start up the application program in accordance with the command line text.

For example, FIG. 11 shows “video” and “address” as parameter values of the command “cmdMain”. And, if “video” is designated as the parameter value of the command “cmdMain”, the application program video.exe will be started up, and if “address” is designated as one of the parameter values, the application program “pim.exe” will be started In the “video” parameter value of the command “cmdMain”, are the parameter values “timer entry”, “view” and “delete” as parameter values of the parameter “Operation”. This parameter “Operation” runs application programs depending upon the process type.

The parameter value “timer entry” indicates that the video recording program is to be run and designates the parameter “/s” in order to run the video recording program and starts up the application program “video.exe”.

Further, the parameter value “view” indicates that the state of the video schedule should be output, so the parameter “/v” is designated to reference the schedule state and the application program “video.exe” is started up.

The parameter value “delete” indicates that a scheduled video recording is to be deleted, so the parameter “/d”, which deletes scheduled video recordings is designated and the application program “video.exe” is started up.

Note that if “address” is designated as a command parameter and “view” is designated as an “Operation” parameter value, the parameter “/v”, which is for referencing the schedule, will be designated and the personal information management application program “pim.exe” will be started up.

In any case, it should be clear without stating explicitly that if any other parameter values have been designated using “cmdParam” in the command line text, those parameters will be designated when the application program is started up.

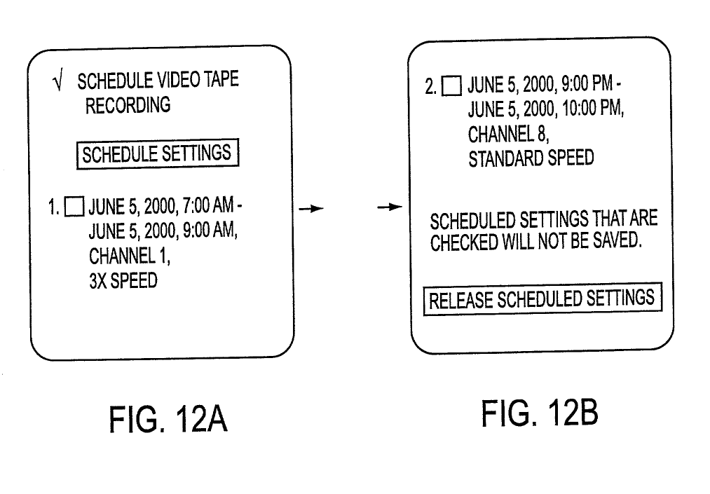

FIG. 12 is a diagram showing the output of the state of the video recorder schedule as in the command line text. The scroll operation moves between the displays in FIG. 12 (a) and FIG. 12 (b).

Selecting “schedule video tape recording” from the menu list of the web page in FIG. 6 and then selecting “reference schedule state” will cause a command line text to be generated and a file to be output.

The remote computer 2 will download this file, analyze the command line text and then, based on the results of that analysis, will designate the parameter “/v” and start up the application program “video.exe”.

The application program will output the state of the video tape recording schedule because the parameter “/v” has been designated. When the program of this invention is operating on the remote computer 2, the state of the schedule will be sent out to the server 3 and the CGI program that is running on the server 3 will provide that schedule state as the web page shown in FIG. 12.

Note that by checking the check-box corresponding to the scheduling information that is to be erased and selecting the “erase schedule” button, a command line text for the purpose of erasing the selected scheduling information will be generated by the CGI program and saved to a file. Next, the program of this invention operating on the remote computer 2 will analyze the command line text contained in that file, start up the application program designated as a parameter of the object specified as scheduling information to be erased and erase the scheduling information in question.

As above, this invention allows the remote operation of a computer. It should also be recognized that having the computer that is operated determine whether a specified file is present on another device, allows for remote operation using a low-load process.

Further, if the server is accessed using a dial-up connection and a telephone line to execute the operation that is indicated in the specified file that was downloaded from the server, it can break the connection after the file has been downloaded and reduce line charges and the need for a dedicated line.

If the address of the device used for the purpose of running the remote operation is registered as the destination of the notice, the user can immediately learn the results of the execution of the remote operation after running the process using the remote computer.

Further still, the user does not directly write the command line text that runs the computer. The system is configured so that the user selects or enters the parameter values and the command line text is generated from those parameters by the program, which helps to prevent errors in the written command line text making it possible to avoid computer malfunctions.

What is claimed is:

1. A processing device comprising:
means for determining whether specific files are on a server separate from said processing device; and
means for executing processes indicated by the specific files if the specific files are present on the server.

2. A remotely operated controlling device comprising:
display unit displaying input forms into which values for categories corresponding selected processing content are input;
retrieving unit retrieving data corresponding to the categories and the values input using the input forms; and
generating unit generating command lines to run processes on another device using the values corresponding to the categories.

3. A remotely operated system comprising:
an administration device; and
a terminal device including a determination unit determining whether specific files are present on said administration device and a control unit executing processes indicated by the specific files if the specific files are present in said administration device.

4. A computer readable storage medium storing a program to perform a method comprising:
determining whether a specific file is present on a computer or other device; and
executing a process indicated by the specific file when the specific file is present.

5. A computer readable storage medium storing a program instructing a computer to perform a method comprising:
generating commands lines that display an input form which inputs values into categories corresponding to a selected process; and
executing the selected process on a device using the values corresponding to the categories after obtaining corresponding data and the categories for which values have been input using the input form.

6. A method comprising:
determining whether specific files are on a server separate from a processing device; and
executing processes indicated by the specific files if the specific files are present on the server.

7. A processing device comprising:
a determining unit to determine whether specific files are on a server separate from said processing device; and
an execution unit to execute processes indicated by the specific files if the specific files are present on the server.

8. The processing device according to claim 6, further comprising:
transferring the specific file that is present on the server to a destination device; and
executing the process indicated by the specific file that was transferred to the destination device.

9. The method according to claim 6, further comprising sending out results of running the process to a device which was used to generate the specific file.

10. The remotely operated controlling device according to claim 2, further comprising a storage unit storing the command lines.
